(19) United States
(12) Patent Application Publication
(10) Pub. No.: US 2008/0176615 A1
(43) Pub. Date: Jul. 24, 2008

(54) Iterative Card Game

(76) Inventors: Gavin Regan, Encinitas, CA (US); Stephen William Head, Kill Devil Hills, NC (US)

Correspondence Address: GORDON & REES LLP, 101 WEST BROADWAY, SUITE 1600, SAN DIEGO, CA, 92101, US

(21) Appl. No.: 11/963,449

(22) Filed: Dec. 21, 2007

Related U.S. Application Data
(60) Provisional application No. 60/876,316, filed on Dec. 21, 2006.

(51) Int. Cl. A63F 13/00; A63F 1/00

(52) U.S. Cl. 463/12; 273/292

(57) ABSTRACT

The present invention provides a method of playing a card game using a deck of cards divided into a plurality of player-specific suits, wherein each card in a suit has an associated point-value. A different suit is assigned to each player. A player-specific card earns points for any player, but may earn more points if it belongs to a player's assigned suit. In some versions of the game, the game is complete after one hand. Preferably, however, ten hands are played but only the highest three hand scores of each player are considered. In this version, the player with the highest three hand scores is the winner, much like the scoring system used in surf, skate, and snowboard contests.

### CROSS-REFERENCE TO RELATED APPLICATIONS

The present application claims the benefit of provisional application Ser. No. 60/876,316 filed Dec. 21, 2006, entitled “ITERATIVE CARD GAME,” which is incorporated by reference into the instant application as if set forth verbatim.

### FIELD OF THE INVENTION

The present invention relates generally to card games, and more particularly to card games with sports themes and with scoring systems based on those sports.

### BACKGROUND OF THE INVENTION

Card games have existed for centuries with widely different versions being played around the world. Over the years, card games and playing cards themselves have undergone many changes. Modernly, the typical deck of playing cards consists of fifty-two cards divided into four suits of thirteen cards each. Each suit is associated with a different symbol (spade, heart, diamond, and club), and each card in a suit is associated with a value ranging from one to thirteen.

Many traditional card games may be classified as pattern games, in which the players try to collect cards in certain patterns, and points are awarded based on the number and type of cards in the pattern. For example, a player may try to collect cards of one suit, consecutively numbered cards, cards of different suits with the same value, or some combination of the foregoing. These games generally are played using a typical fifty-two card deck. Examples of pattern card games include poker and rummy.

More recently, card games have been developed that do not use the traditional deck of fifty-two cards and four suits. Often the cards used in these games have characters printed on the face, and the different characters have different “abilities” or “powers.” Unlike a traditional deck of cards, the value of a given card is not determined by the number of symbols printed on its face, but instead by the “strength” of the character's abilities or powers.

To play these types of games, two or more players play a card against each other. Essentially, the player whose card has the character with the strongest ability or power wins the hand. Frequently, the winning player gets to keep the card, or other cards, of the losing player. In this way, a player can accumulate many cards by defeating many opponents. Another way a player can accumulate many cards is by purchasing more. As a particularly powerful card is likely to defeat many opponents, players of these games often collect the cards, attempting to amass an arsenal of the most powerful cards.

Also in recent history, board riding sports such as surfing, skateboarding, snowboarding, and wakeboarding, have become increasingly popular. These sports, which at one time were only practiced by very few people, are now mainstream activities. As these sports became popular, new types of contests arose. Unlike traditional sports contests which typically have an objective scoring system, these contests are generally judged subjectively based on the difficulty of maneuvers performed by the contestants.

In a typical format, several competitors compete in a single “heat,” and the judges rate the difficulty and execution of maneuvers performed by the competitors during the heat. The competitor (or competitors) with the highest heat score advance to the next round where he or she will compete against other heat winners in a new heat. This process is repeated until one competitor has the highest score at the end of the final heat. This competitor is the winner of the contest.

In surf contests, several competitors enter the water for a timed heat. Each competitor tries to catch as many high-scoring waves as possible before the heat is over. The score a surfer receives on a given ride depends on factors such as the size of the wave, the length of the ride, the difficulty of the maneuvers performed, and the quality of execution of the maneuvers. Generally, each competitor discards all wave scores except for the two or three highest scores. The competitor with the highest total wave score wins the heat and advances to the next round. This process is repeated until one competitor wins the final heat, thus winning the contest.

In skateboard contests, each competitor generally gets two or three timed “runs” on the skate ramp or park. The competitor tries to perform as many difficult maneuvers as possible before time runs out. The score of a skater receives depends on the number and difficulty of maneuvers executed, the height attained in each maneuver, and the speed and smoothness with which the maneuvers are performed. Generally, each competitor discards his or her lowest one or two run scores, and the competitor with the highest total run score wins the heat and advances to the next round. This is also a common format for snowboard, BMX, and wakeboard contests.

Enthusiasts of these individual sports are often passionate about them and eager to incorporate them into other recreational activities. For example, video games based on these sports are more popular than ever, largely due to the fact that players enjoy competing against friends in a simulated world where they are experts at their sport of choice. However, video games obviously require a source of electricity, and playing with multiple friends requires communication between the video game systems. Accordingly, there is a need for a simple, portable game that allows sports enthusiasts to compete against friends in a simulation of their sport of choice. There is also a need for a card game that combines the best aspects of pattern card games and collectible card games.

### SUMMARY OF THE INVENTION

The present invention satisfies these needs by providing a collectible card game in which points are awarded based on the patterns of cards held in each player's hand. Furthermore, the scoring system of the card game is based on the scoring systems used in various sports, preferably sports such as surfing, skateboarding, and snowboarding. As such, sports enthusiasts are now able to participate in a card game that combines the best aspects of traditional and modern games, along with the scoring system of their favorite sport.

The present invention provides a method of playing a card game using a deck of cards divided into a plurality of player-specific suits, each card in the player-specific suits having an associated point value. After selecting a group of players to play the game, a different suit is assigned to each player. A dealer is selected and deals an equal number of cards to each player, placing the remaining cards face down. The top card in the deck is turned face up and placed next to the rest of the deck in order to form a discard pile. The player to have the first turn is selected, the turn giving the player the option to draw a card from the deck, the discard pile, or to not draw any card. After the player's turn is over, another player in the group gets a turn. This process is repeated until every player has had at least one turn, at which point the hand may be completed. The winner of the hand is the player who collected the most, highest value cards in any suit, although more points may be awarded for collecting cards in that player's assigned suit.

The deck of cards may further include cards not belonging to player-specific suits, such as scoring cards or special cards, in addition to the cards in player-specific suits described above. These scoring or special cards may affect a player's hand score, final score, or may allow the player to take a special action or score points in a manner otherwise not permitted by the rules. The game may also incorporate a random selection device, such as a die, in order to assign suits, determine the dealer, determine the order of play, or make any other choice or selection involved in the game.

In some versions of the game, the game is complete after one hand. In other versions, several hands are played and the winner of the game is the player with the highest total score. Preferably, ten hands are played but only the highest three hand scores of each player are considered. In this version, the player with the highest three hand scores is the winner, much like the scoring system used in surf, skate, and snowboard contests. Any version of the game may be implemented as a program on a computer.

Although the general nature of the game has been summarized, it is to be understood that many variations of the game are within the same general concept. The precise rules of the game may vary from version to version without departing from the spirit of the invention. For example, after a player draws a card, the player may be required to discard a card immediately, at the end of the hand, or not at all. The number of turns in a hand, the number of cards in a hand, the number of cards and suits in the deck, the number of players playing the game, and the number of hands in a complete game all may vary in different versions of the game. It is also to be understood that the present invention is not limited to physical cards. Instead, virtual cards may be used and the game may be played on a computer.

### BRIEF DESCRIPTION OF THE DRAWINGS

FIG. 1 is a flow chart showing the steps involved in playing a complete game, according to one embodiment of the invention.

FIG. 2 is a flow chart showing the steps involved in playing a hand, according to one embodiment of the invention.

FIG. 3 is a flow chart showing the steps of scoring a hand, according to one embodiment of the invention.

FIG. 4 is a flow chart showing the steps of scoring a game, according to one embodiment of the invention.

FIGS. 5, 6, 7, 8, 9, and 10 show the starting hands held by Players 1-6 in an illustrative example of a hand of a game.

FIGS. 11, 12, 13, 14, 15, and 16 show the finishing hands held by Players 1-6 in an illustrative example of a hand of a game.

FIG. 17 is a scorecard showing the scores of Players 1-6 in an illustrative example of a game.

FIG. 18 shows a computer network used to implement one embodiment of the invention.

FIG. 19 shows a schematic illustration of a computer of FIG. 18.

### DETAILED DESCRIPTION

Exemplary embodiments of the invention are described in detail below with reference to the appended figures, wherein like elements are referenced with like numerals throughout. It is to be understood that the invention is not limited to the embodiments described below; rather, the scope of the invention is defined by the appended claims. The figures are not necessarily drawn to scale and do not necessarily show every detail or structure of the various embodiments of the invention, but rather illustrate exemplary embodiments and features in order to provide and enabling description of such embodiments.

The methods of playing a card game described herein may involve the use of a non-standard deck of cards. The deck of cards includes at least cards belonging to player-specific suits (i.e. “suited cards”), and may further include scoring cards and special cards. At least one suit is assigned to each player. A card of a given player-specific suit earns more points (e.g. bonus points) for the player to whom that suit is assigned. In some embodiments, such a card only earns points for the player to whom that suit is assigned. Scoring cards, by contrast, can earn (or lose) points for any player and are not divided into suits. In some versions of the game, the deck of cards further comprises special cards. Special cards do not directly affect a player's score, but instead allow the player to take an action that is otherwise prohibited by the rules, such as playing out of turn, or earning bonus points for playing a card not in the player's assigned suit.

In an exemplary embodiment, the game begins by selecting a group of players and a dealer who deals an equal plurality of cards to each player. The remaining deck of cards is placed face down in the center of play. The top card is pulled from the deck and placed face up next to the deck, thus creating a discard pile. A player is selected to have the first turn. This first player has the option of taking the top card off the deck, taking the top card off the discard pile, or doing nothing at all. If the player draws a card, he must then discard a card so that the number of cards in his hand is constant. After the first player's turn, the second player's turn follows in the same way. This process repeats until every player has had an equal predetermined number of turns, thus ending one hand.

During each hand, every player's goal is to collect as many high-value cards in a single suit as possible, preferably in the player's assigned suit. Additionally, each player tries to collect beneficial scoring cards. At the end of each hand, each player's score is determined. The sum of the values of the cards in a single suit held by each player is determined, and may be modified positively or negatively by scoring cards held by any player. Bonus points may be awarded based on the number of cards played by a player, or if the card(s) played belong to the player's assigned suit. Each player's score for the hand is recorded, and then a new hand begins. The process is repeated during each new hand until a predetermined number of hands have been played, thus ending a round of play. The winner of the round is the player with the highest total hand score, which may be computed from all of the hand scores, or from only a portion of the hand scores.

The Deck of Cards

As mentioned above, the deck of cards used in the present method is divided into different suits assigned to each player. In general, cards earn points for any player, but earn more points (e.g. bonus points) for a player if they belong to the player's assigned suit. The deck should include at least two different suits and, although any number of suits may be used, the ideal number of suits is six. The indicia used to identify each suit can be anything capable of distinguishing the cards, from colors and/or symbols to fictional characters. For example, and without limitation, each suit of player-specific cards may be associated with an athlete (real or fictional) or a character in a movie, television series, or book.

The point value of each card in the player-specific suits may be associated with a theme of the game. For example, in a sports-themed game in which the suits each correspond to a different athlete, the value of each card in a suit may be associated with a different action performed by athletes in the particular sport. Difficult or more unusual actions may have high point values, while simple or commonplace actions have lower point values. Some cards may require the holder to roll a die to determine the card's value. Players attempt to collect as many high-value cards in a single suit as possible. However, players preferably collect high-value cards in their assigned suit in order to maximize their score by earning bonus points.

The deck of cards may also include scoring cards, which do not belong to player-specific suits and can both benefit and harm every player in the game. Certain scoring cards may affect the holder's hand score, the holder's final score, other players' hand scores, or other players' final scores. Some scoring cards may require the holder to roll a die, which determines the value of the scoring card and/or which player gains or loses the points. If a player holds a negative scoring card, in some versions of the game the player may discard it if the player rolls her own symbol on the die. The indicia identifying the scoring cards can be as simple as colors and/or symbols, or they can depict events or actions consistent with an overall theme of the game, such as a sport.

The deck of cards may further comprise other types of cards. For example, the deck of cards may further comprise special cards. Special cards are cards that do not belong to player-specific suits and allow the holder to take an action that is otherwise prohibited by the rules. For example, and without limitation, special cards can allow the holder to play out of turn, take a good card from another player, give a bad card to another player, or earn bonus points with cards in a suit assigned to another player.

The proportion of suited cards to other cards impacts the character of the game. If the deck has too many suited cards, the game tends to be too uniform with too little variation from hand to hand. However, if the deck has too few suited cards (and therefore too many scoring cards and/or special cards), the game becomes too dependent on good luck instead of good strategy. Although the exact proportion of suited cards is not critical and can range anywhere from 0% to 100% of the deck, suited cards should make up between about 50% and 80% of the deck. In an exemplary embodiment, suited cards make up about 73% of the deck.

The Scoring System

The basic concept of the scoring system is that the overall winner of the game is determined based on the cumulative score of several (but not necessarily all) of the hands played. Suited cards earn more points (e.g. bonus points) for a player if they belong to the player's assigned suit. In some versions of the game, cards earn points for a player only if they belong to the player's assigned suit. Therefore, the basic strategy of the game is for the player to fill her hand with high-value cards in any one suit (preferably in her assigned suit), while at the same time trying to prevent her opponents from picking up high-value cards (particularly in their assigned suits). Players may receive bonuses for playing cards in their assigned suit, or for playing every card in their hand. Unsuited scoring cards, which can benefit or harm every player equally, are optionally added to the deck in order to make the game more action-filled and potentially higher scoring. Furthermore, a die may be incorporated into the scoring, such that the value of a card or hand is modified according to the value shown on the die.

An alternate version of the basic scoring system further classifies the suited cards in into two or more sub-types. A player scores points by collecting cards of every sub-type in one suit (and bonus points if they are in the assigned suit). For example, in a baseball-themed game, there may be three sub-types of suited cards, such as “runners on base,” “swing power,” and “pitch.” To score points, a player's hand must have at least one card from each sub-type in the player's assigned suit. For example, a player could have a “2 runners on base” card, a “medium swing power” card, and a “fastball” card. According to the rules of the game, various combinations of cards are worth different amounts of points. In this example, the player's hand may be worth one run. If instead of the “medium swing” card the player held a “homerun swing” card, the player's hand would be worth three runs. Although a baseball-theme game has been used here as an example only, it is to be understood that this scoring system, in which sub-types of suited cards must be combined, can be used in games of any theme.

Selection of Group of Players and Assignment of Suits

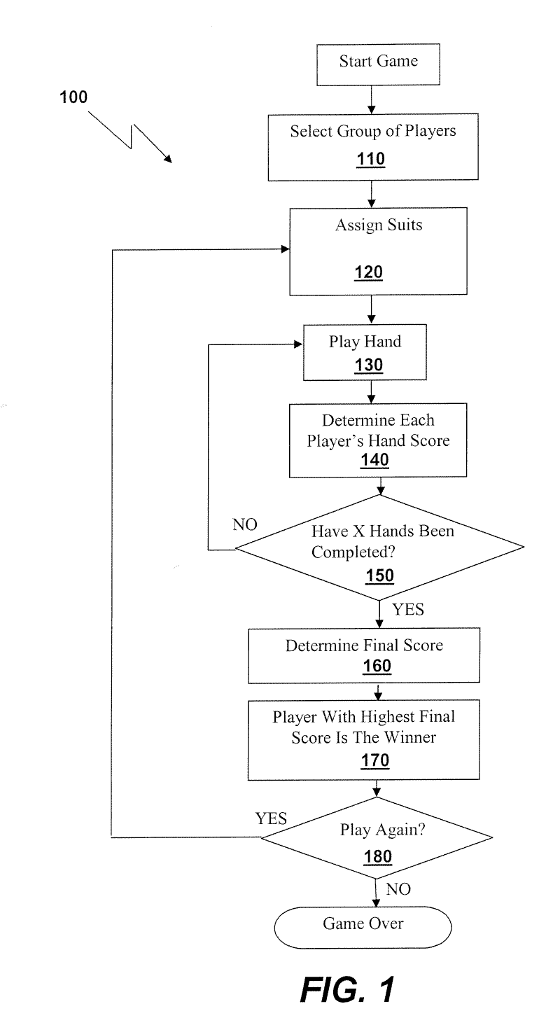

Referring now to the flow chart in FIG. 1, a generic version of the game (100) will be described. It is to be understood that this example is not intended to be limiting, but instead is provided for illustrative purposes only. The first step is the selection of a group of players (110). The “group” may be as small as a single person, who can play a solitary version of the game. The maximum number of players in the group is a number of players equal to the number of suits. For example, if there are six suits, then the group of players must be no greater than six.

Next, at least one suit is assigned to each player (120). This assignment may be made voluntarily or randomly. Throughout this specification, whenever a selection of any kind is made “randomly,” it is to be understood that, unless a specific method is identified to the exclusion of others, any means of substantially random selection may be used. For example, and without limitation, methods of random selection include rolling any number of dice (including a single die), drawing an unknown card from a deck of cards, and spinning a selection wheel.

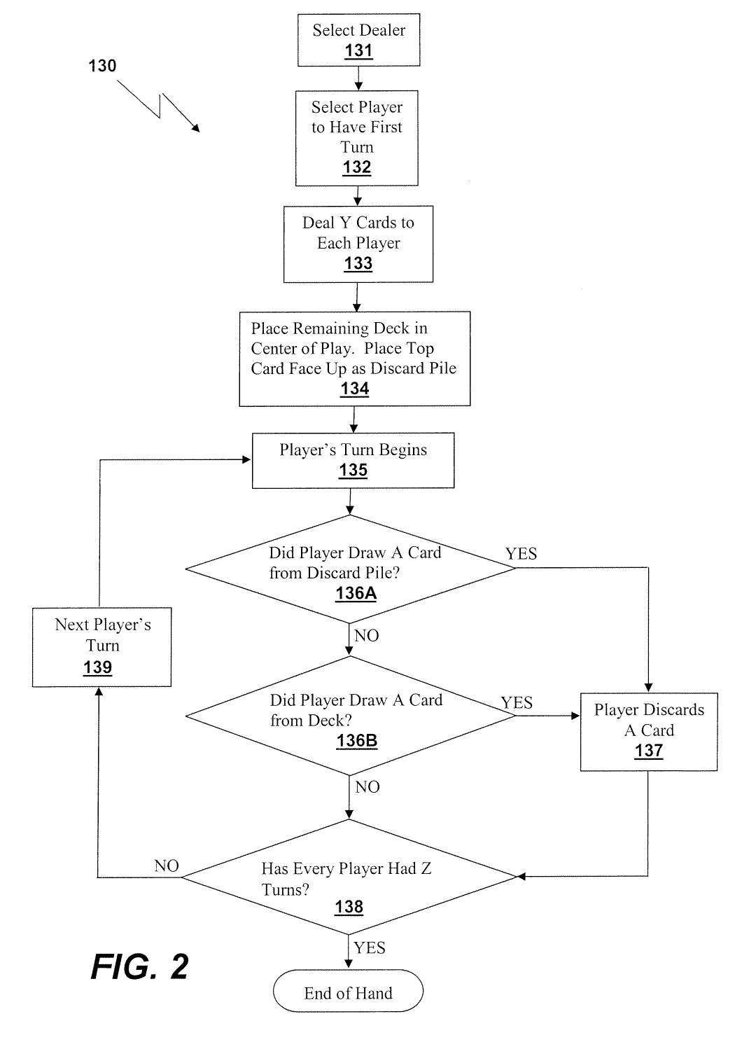

Once the group of players is selected (110), and at least one suit is assigned to each player (120), it is time to start playing a hand (130). The steps of playing a hand are shown in more detail in FIG. 2. First, a dealer is selected (131). The dealer may or may not be one of the group of players. The dealer may be selected voluntarily or randomly. Furthermore, the dealer may change every hand, change some hands, or remain the same the entire game. The dealer may or may not also be a scorekeeper. Although score must be kept in order to determine a winner, a dedicated scorekeeper is not an absolute requirement, but is instead optional because each player may keep track of his own score.

Next, the player to play first is selected (132). This is generally the person sitting to the left of the dealer, but the first turn may also be assigned by agreement of the players or randomly. The dealer then deals an equal plurality (Y) of cards face down to each player (133). The exact number of cards dealt to each player varies in different versions of the game. However, in no case should the hand size be less than two cards. Although there is theoretically no maximum hand size, the game becomes cumbersome if the hand size is over about eight cards. In an exemplary embodiment the hand size is five cards. After the dealer finishes dealing, she places the remaining deck of cards face down in the center of play, removes the top card, and places it face up to begin the discard pile (134).

A player's turn (135) begins with the player deciding whether to draw a card. Each player's primary goal is to collect high-value cards in one suit, preferably in the player's assigned suit. Therefore, a player will first examine the card in the discard pile. If it belongs to the player's assigned suit or has a high value, or if it is a beneficial scoring card, the player will consider picking it up if it is better than any card already in his hand. However, the player may also believe that an even better card still remains in the deck. Thus, he may wish to take a risk and draw an unknown card. If the card in the discard pile does not improve the player's hand, he will almost certainly draw an unknown card. However, if the player's hand is so good that it is unlikely to improve no matter what he draws, he may optionally do nothing and pass his turn to the next player. After the player draws a card from the discard pile (136A) or from the deck (136B), he discards a card (137) so that the number of cards in his hand remains constant. In alternate versions of the game, players do not discard any cards until the end of the hand, rather than on every turn.

After each turn, it must be determined whether each player has already had a predetermined number (Z) of turns (138). If not, it is the next player's turn (139) and the hand continues. If each player has had the predetermined number of turns, the hand is over. The number of turns per player per hand varies in different versions of the game. Although there can be as few as one turn per player per hand, in an exemplary embodiment there are three turns per player per hand.

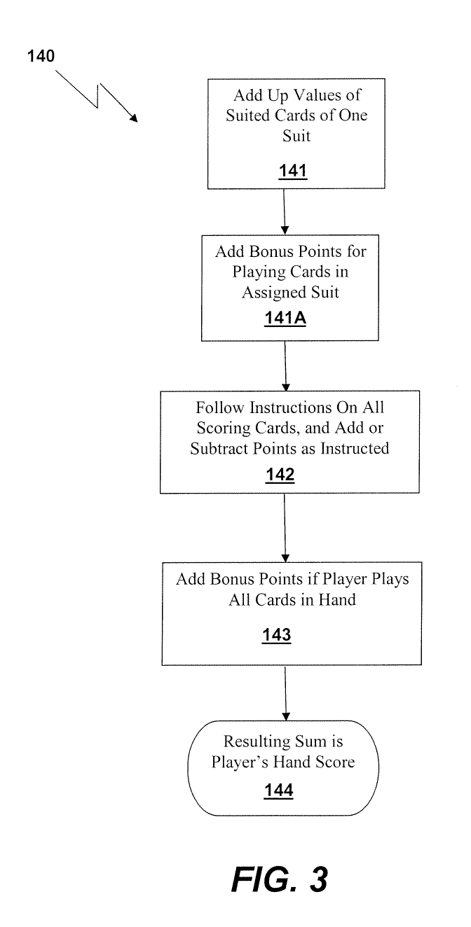

Again referring to FIG. 1, after a hand (130) is complete the score of each player's hand is determined (140). Referring now to FIG. 3, the sum of the values of the suited cards (of any single suit) held by each player at the end of the hand is determined first (141). In some versions of the game, the player receives bonus points (141A) added to his score if the cards he plays belong to his assigned suit. Likewise, in some versions of the game, the player receives no points for playing a card that does not belong to the player's assigned suit. Next, this sum is modified according to any scoring cards (142) in the player's hand, and possibly according to scoring cards in an opponent's hand. Then, in some versions of the game, if the player played all cards in his hand, the player receives bonus points added to his score (143). This modified score is the player's hand score (144). In different versions of the game, a die may be incorporated into the scoring.

Returning to FIG. 1, after a hand (130) is completed and scored (140), it must be determined whether a predetermined number (X) of hands have been played (150). If not, another hand (130) is played. If the requisite number of hands has been played, then it is time to determine each player's final score (160). This predetermined number of hands may be as few as one hand, or as many as dozens of hands. However, in an exemplary embodiment there are ten hands per game.

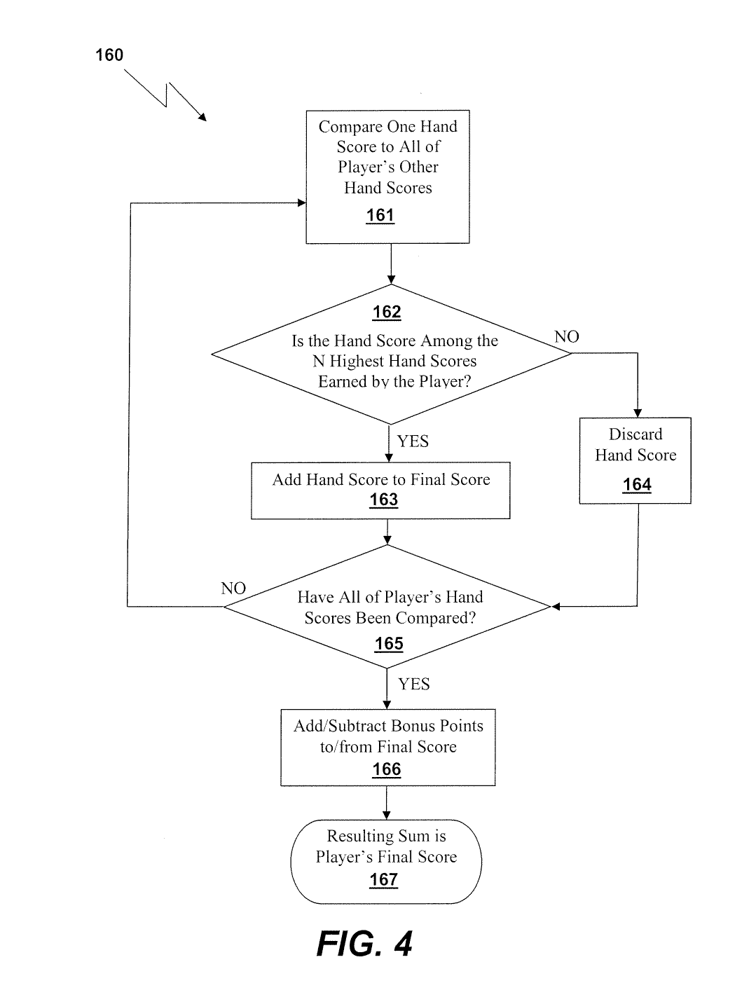

Referring to FIG. 4, a player's final score is determined (160) by adding up a predetermined number (N) of her highest hand scores, and modifying this sum according to any relevant scoring cards drawn by any player throughout the game. The player looks at each hand score in turn and compares it to all of her other hand scores (161). If it is among a predetermined number of her highest hand scores (162), she adds the hand score to her final score (163). If the instant hand score is not among the predetermined number of her highest hand scores (162), then she discards it (164). In an exemplary embodiment, the predetermined number of highest hand scores is three.

After completing the analysis of one hand score, the player determines whether all of her hand scores have been compared (165). If not, the player moves on to the next remaining hand score and compares it to the others (161). If all hand scores have been compared, and the highest hand scores added to the final score (163), the player then follows the instructions on any bonus cards (166), which may be included in some embodiments of the invention. The bonus cards may be held by the player or by an opponent, and they may add or subtract points to or from the player's final score. The resulting total is the player's final score (167).

The final scores of all the players are compared, and the player with the highest final score is the winner (170). The group of players then decides whether to play again (180). If they do, they return to the step of assigning suits to each player (120). If they do not, the game is over.

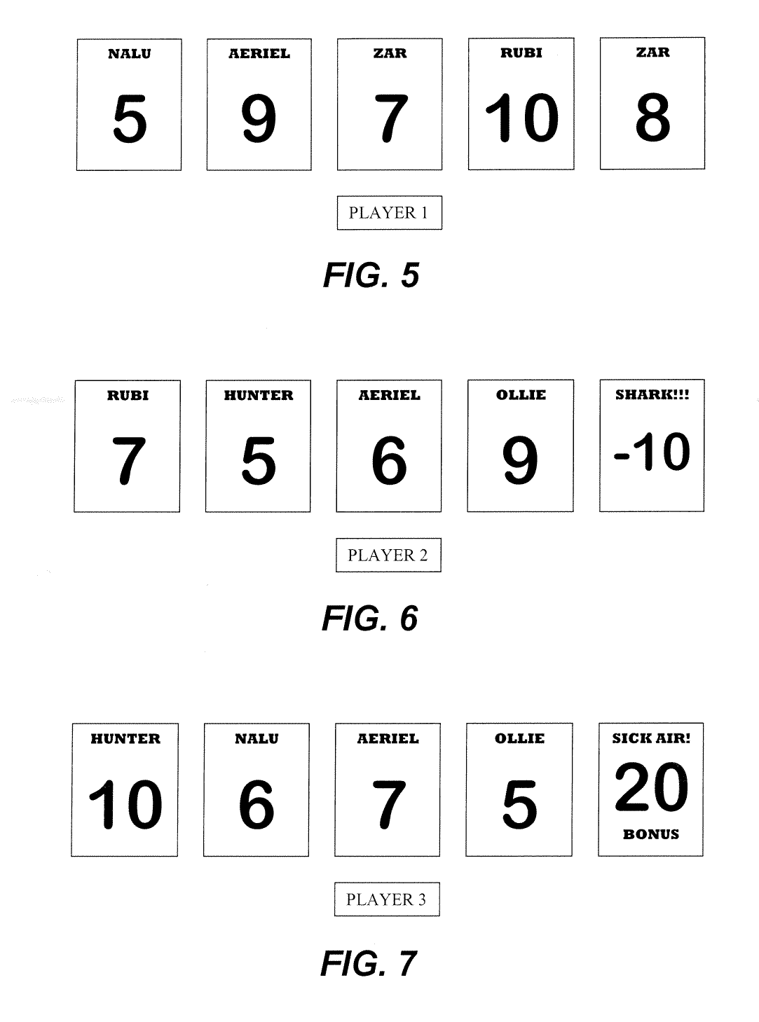

An exemplary embodiment of the present card game is now discussed with reference to FIGS. 5-17. The flow charts of FIGS. 1-4 describe the general game play of the present embodiment. In the present embodiment, the theme of the game is surfing and there are six player-specific suits of cards, each of which corresponds to a different fictional surfer/character. The cards in the player-specific suits depict surfing maneuvers being performed by each of the surfers. There are 72 cards in player-specific suits, and 26 scoring or special cards. There are six character cards that correspond to the six fictional surfers (and thus to the six player-specific suits as well). There is also a six-sided die with six sides corresponding to the six fictional surfers.

In this surf-themed version of the game, the scoring system mirrors a professional surf contest. Each hand is a simulated wave, and the suited cards held in each player's hand are simulated maneuvers performed by the player's assigned character on the wave (i.e. during the hand). The score of each wave (hand) depends on the number and value of the maneuvers performed, as modified by relevant scoring cards held by the players. The first “heat” is over after every player has “surfed” ten waves (i.e. played ten hands). The three highest wave scores of each player are totaled, and the player with highest three-wave score is the heat winner.

A sample game between six players (“Player 1,” “Player 2,” etc.) is now discussed. To start the game, each of the players selects one of the character cards to determine which suit of is assigned to each player (120). If two players each want to play as the same character, the assignment is made randomly instead of voluntarily. In this sample game, the players make the following character selections: Player 1 chooses “Hunter Noll,” Player 2 chooses “Rubi Palmer,” Player 3 chooses “Zar Richards,” Player 4 chooses “Nalu Keakona,” Player 5 chooses “Aeriel King,” and Player 6 chooses “Ollie Banks.”

Next, a dealer is selected (131). Because in this sample game the players cannot agree on one person to be the dealer, a dealer is selected randomly by rolling the die. Whichever player's symbol is first to turn up on the die is the dealer. In this sample game, the “Hunter Noll” symbol turned up on the die, and therefore Player 1 is selected as the dealer.

Player 1 deals five cards face down to each player. The starting hands of each player are shown in FIGS. 5-10. For the sake of clarity, the actual cards are not depicted and instead only the point value and suit (as indicated by character name) of the cards are shown. Player 1 then places the remaining deck face down in the center of play, removes the top card from the deck, and places it face up in the center of play to start the discard pile (134). In this sample game, the first card in the discard pile is a five-point maneuver performed by Rubi Palmer.

Player 2 is randomly selected to have the first turn (132) by a roll of the die. As seen in FIG. 6, Player 2 was dealt a seven-point maneuver performed by Rubi Palmer, three maneuvers performed by other characters, and one Shark card worth negative ten points. Player 2's hand can be improved, and therefore Player 2 chooses to draw a card (136). The card in the discard pile will improve Player 2's hand because it is a five-point Rubi Palmer maneuver, so Player 2 picks it up. Player 2 must now discard one card so that her hand always contains five cards. Because the Shark card is the worst card in her hand, Player 2 discards it (137) by placing it face up in the discard pile. Player 2's turn is now over.

As seen in FIG. 7, Player 3's starting hand contains four maneuvers, but none performed by his character, Zar Richards. Player 3's starting hand also contains one Sick Air scoring card worth twenty points. Player 3's hand can improve, so he chooses to draw a card (136). The Shark card in the discard pile is no help, so Player 3 draws the unknown card on top of the deck, which turns out to be a Zar Richards ten-point maneuver. This is a big help for Player 3, so he keeps this card and discards an Ollie Banks maneuver card (137). Player 3's turn is now over.

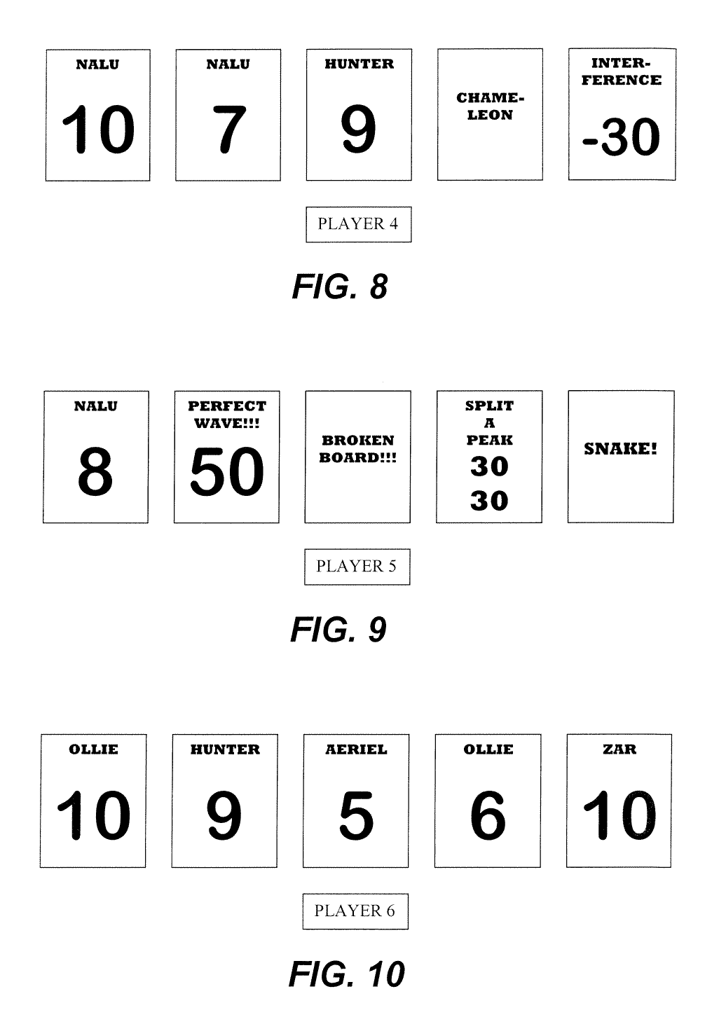

As seen in FIG. 8, Player 4's starting hand contains one Nalu Keakona ten-point maneuver, one Nalu Keakona seven-point maneuver, one Hunter Noll nine-point maneuver, a Chameleon special card, and an Interference negative scoring card. This is a very good starting hand, with the exception of the Interference card. The Chameleon is a special card that allows Player 4 to treat maneuver cards from other characters as maneuver cards of a desired character (here, Nalu Keakona). The card in the discard pile does not help Player 4, so he draws the unknown card from the top of the deck (136), which turns out to be an Ollie Banks maneuver. Although this card does not help Player 4 a lot, it does not hurt him, unlike the Interference card already in his hand. Accordingly, Player 4 keeps the Ollie Banks card and discards the Interference card (137). Player 4's turn is now over.

Referring to FIG. 9, Player 5's starting hand contains one Nalu Keakona card, a Perfect Wave positive scoring card, a Broken Board negative scoring card, a Split A Peak positive scoring card, and a Snake special card. As the Interference card in the discard pile is no help, Player 5 draws an unknown card (136) off the top of the deck, which turns out to be an Aeriel King nine-point maneuver. Player 5 keeps this card and discards the Broken Board card (137). Player 5's turn is now over.

As shown in FIG. 10, Player 6's starting hand contains two Ollie banks maneuvers, one Aeriel King maneuver, one Hunter Noll maneuver, and one Zar Richards maneuver. The Broken Board card in the discard pile does not help Player 6, so he draws an unknown card (136), which turns out to be an Ollie Banks five-point maneuver which will improve his hand. Player 6 does not have any negative scoring cards, so it is not immediately apparent which card he should discard. Player 6 knows that Player 1's character is Hunter Noll, so he chooses not to discard his Hunter Noll maneuver card because that would help Player 1 by giving him the chance to pick it up off the discard pile. Player 6 decides to discard the Aeriel King maneuver card (137), thus ending his turn.

Although it is now Player 1's turn, Player 5 yells “snake!” and plays her Snake special card. This allows Player 5 to take the Aeriel King maneuver card off the discard pile even though it is not her turn. Player 5 does not need to discard another card because she has already placed the Snake card in the discard pile. Player 1's turn now resumes, and he can either pick up the Snake card from the discard pile or draw an unknown card. Referring to FIG. 5, Player 1's hand contains only other characters' maneuver cards, and he decides to draw an unknown card (136). The card turns out to be a six-point Hunter Noll maneuver card, which Player 1 keeps, discarding one of the other maneuver cards (137). Player 1's turn is now over and every player has now had one turn.

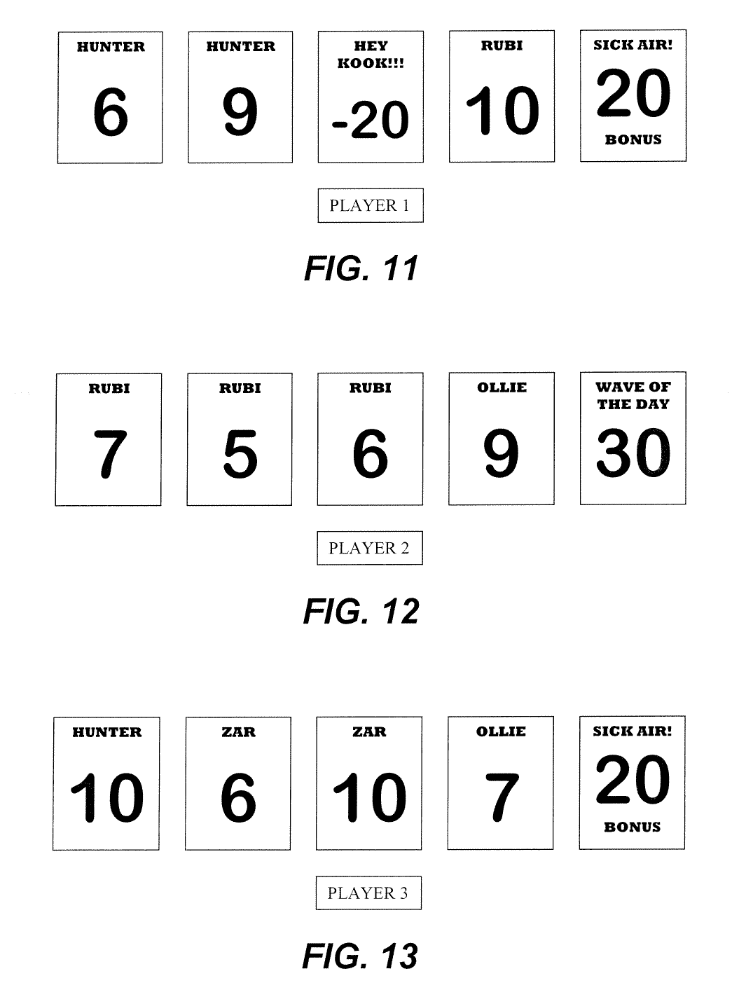

This process of taking turns is repeated until every player has had three turns (138). A player is considered to have taken a turn even if the player chooses not to draw a card. The hands of the players after three turns are shown in FIGS. 11-16. As can be seen, all of the players were able to collect better cards than they were dealt, although some players were more successful than others. Each player determines his or her wave score (144) (i.e. their score for this hand) by adding up the values of the maneuver cards (i.e. suited cards) in any one suit (141) and any scoring cards held (142). In this version of the game, players receive 10 bonus points added to their wave score (141A) for playing assigned suit cards, and 5 bonus points added to their wave score 143 if they are able to play every card in their hand. If a player holds a negative scoring card, it may be discarded without penalty if the player successfully rolls his or her character's symbol on the die. If the player is unable to roll this symbol, the player must take the penalty identified on the card.

Referring to FIG. 11, Player l's wave score is determined by adding up the values of the suited cards in one suit (here, Player 1's assigned suit/character) and the scoring card (6+9+20=35). Additionally, Player 1 receives a 10 point bonus in his wave score because he played cards in his assigned suit. Thus, Player 1's wave score is 35+10=45 points. The negative twenty point Kook card does not affect Player 1's score. Instead, it allows Player 1 to take 20 points off an opponent's wave score.

Referring to FIG. 12, Player 2's wave score is determined by adding up the values of the cards in one suit and the scoring card (7+5+6+30=48) plus a 10 point bonus for playing cards in her assigned suit, for a total wave score of 58 points.

Referring to FIG. 13, Player 3's wave score is determined by adding up the values of the cards in one suit and the scoring card (6+10+20=36) plus a 10 point bonus for playing cards in his assigned suit, for a total wave score of 46 points. However, Player 1 decided to play his Kook card against Player 3. This causes Player 3 to lose 20 points and makes his actual wave score only 46−20=26 points.

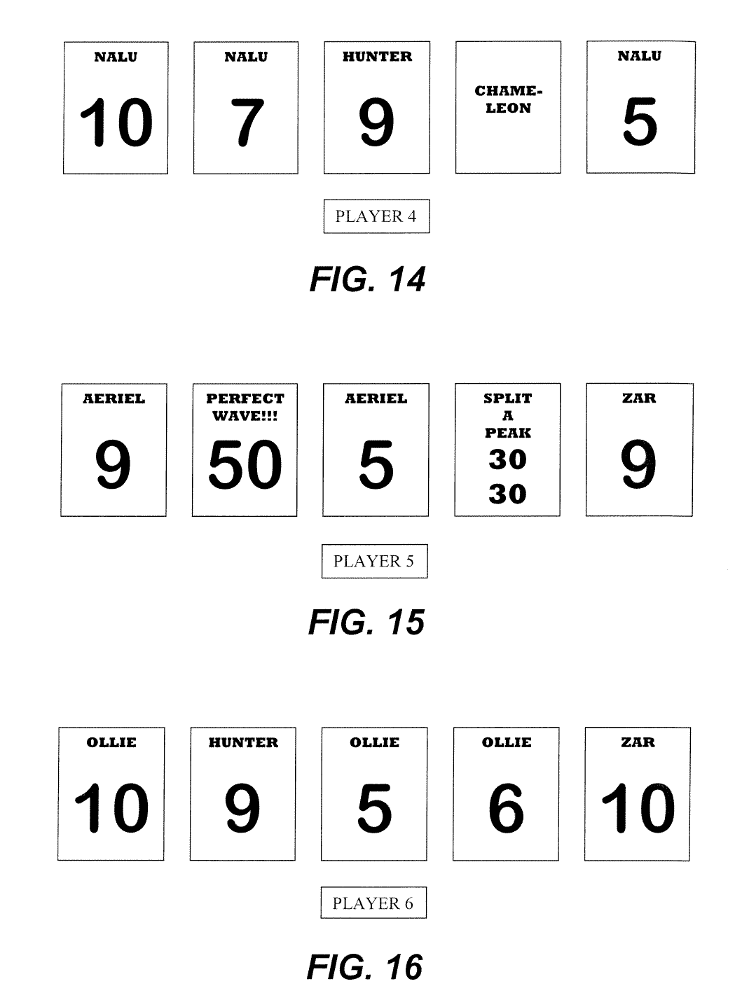

Referring to FIG. 14, Player 4 holds three Nalu cards, one Hunter card, and a Chameleon card. Player 4 plays the Chameleon card, which makes all suited cards into a player's desired suit (in this case, Nalu), and which itself is treated as a 10 point card in the player's desired suit. In this version of the game, when all of the suited cards in a player's hand belong to that player's assigned suit, the player gets an opportunity to roll the game die. If the player rolls his or her own suit/character, the player receives an automatic 100 point wave. If the player does not roll his or her own color, the wave is scored normally.

Here, Player 4 did not roll Nalu on the die, and so Player 4 does not receive an automatic 100 point wave. However, Player 4 played every card in his hand to earn a 5 point bonus, and played cards from his assigned suit (i.e. the Nalu cards) to earn a 10 point bonus. Thus, Player 4's wave score is 10+7+9+10 (Chameleon card)+5+5 (bonus)+10 (bonus)=56 points.

Referring to FIG. 15, Player 5's preliminary wave score is determined by adding up the values of the cards in one suit and the scoring cards (9+50+5+30=94) plus a 10 point bonus for playing cards in her assigned suit, for a total wave score of 104 points. The Split A Peak scoring card also requires Player 5 to give 30 points to an opponent, determined by a roll of the die. Player 5 rolls Player 6's symbol, and therefore Player 6 gets an additional 30 points added to his wave score.

Finally, referring to FIG. 16, Player 6's preliminary wave score is 10+5+6=21 points. Additionally, Player 6 gets a 10 point bonus for playing cards in his assigned suit, for a wave score of 21+10=31 points. Furthermore, Player 6 also gets to add 30 additional points to his wave score, thanks to the Split A Peak card held by Player 5. Therefore, Player 6's wave score is 31+30=61 points.

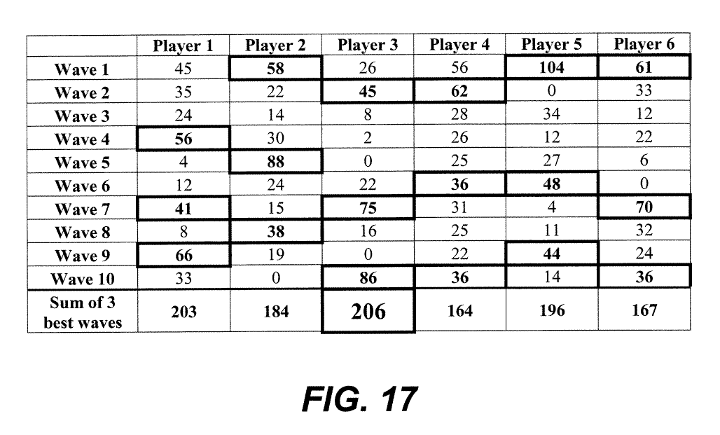

Once every player's score is recorded, it is time for all of the players to catch another wave (i.e. it is time to deal another hand) 130. The players return all of their cards to the dealer, who shuffles the deck and deals five cards face down to every player. The procedure of this hand, and every hand thereafter, is identical to the procedure just described for the first hand. For the sake of brevity, the remaining nine waves (hands) in the heat will not be described in detail, but are instead summarized in FIG. 17 where each player's three best waves are in bold. Each player's final score for the heat 160 is determined by adding up the player's three best waves 163, and further adding any bonus points 166 accumulated by the player throughout the heat. In the embodiment of the invention presently discussed, however, no bonus cards are included. As seen in FIG. 17, the winner of the heat is Player 3 with a final heat score of 255.

As previously discussed, the scoring system used in the present game is the essentially the same scoring system used in surf contests. In surf contests, this scoring system rewards the inconsistent but spectacular surfer who can achieve very high scores on a few waves, but who gets very low scores on the vast majority of waves. This scoring system therefore penalizes a surfer who consistently achieves mediocre scores but rarely gets exceptionally high scores.

The use of the surf contest scoring system in the present card game leads to interesting strategies for the players. As seen in the results in FIG. 17, Player 4 was by far the most consistent player. Player 4 received a wave score in the twenties or thirties on all but one wave, which was actually his highest score. Player 4's reward for this remarkable consistency is a last place finish. Player 3, by contrast, was by far the most inconsistent player, scoring under ten points on several waves. However, because Player 3 had three very high scoring waves, Player 3 is the heat winner. Thus, the scoring system used in the present card game will affect players' strategy. If a player is too conservative and tries to get some points on every wave (hand), the player is unlikely to have any extremely high scores. Instead, the proper strategy is to be aggressive and try to get extremely high scores on just a few waves, even if it risks getting low scores on several waves. This is similar to the strategy frequently used in surf contests, where a surfer will attempt risky maneuvers to get the highest score possible on a single wave. For this reason, the scoring system of the present invention adds a new dimension to card games that will appeal to enthusiasts of surfing or other sports.

In the version of the game just discussed, the number of players was equal to the number of suits. However, this will not always be the case as sometimes a smaller group of people will want to play. Accordingly, various methods of playing the game with other numbers of players will now be discussed.

Still referring to the surf-theme card game previously discussed, in which there are six fictional surfer characters corresponding to six suits of cards, a method of playing the game with five players is provided. In one version of the five-player game, the entire extra suit of cards corresponding to the unassigned surfer character is taken out of the deck, leaving five suits of remaining. The game play can then proceed in the same fashion as the six player game. Alternatively, the extra suit of cards can be left in the deck, and players receive points for playing cards in any suit, including unassigned suits.

Similar methods are used to play the game with four players. In one version, the extra two suits are removed, leaving one suit remaining for each of the four players, who play the game as previously described. In another version, the extra two suits remain in the deck and players can score with cards of any suit. Alternatively, the extra two suits may remain in the deck, with only two players allowed to score with them on a given hand. The players who get to use the extra two suits rotate every hand, either sequentially or randomly.

When three players play the game, there is no need to sequentially or randomly assign the extra suits each hand. Instead, because the number of suits is evenly divisible by the number of players, the suits assigned to each player are constant throughout the heat. In one version of a game of three players, each player is assigned two suits, and any given wave (hand) can include maneuvers (i.e. suited cards) by both of a player's assigned surfers. In different versions of the game, players may score only with cards in their assigned suits, or with cards in any suit. Alternatively, the extra three suits may be removed from the deck so that each player only has one assigned suit, and the game proceeds in a manner analogous to the regular six player game.

In a two player game, there are several possible versions of playing the game. First, all of the cards may be left in the deck, and three suits assigned to each player. Each player is free to use maneuvers from any of his or her three assigned surfers on any given wave. Alternatively, two suits may be removed from the deck, and two suits assigned to each player, so that each player can use maneuvers from any of his or her two assigned surfers. Also alternatively, all four extra suits may be removed from the deck, leaving one suit for each player. Finally, all suits may be left in the deck and only one suit assigned to each player, with players allowed to score with cards of any suit.

Finally, a one player game is also possible. In the solitary version, any number of suits may remain in the deck, including the full six, although at least two suits must always be used. In some versions, the player can only score with cards in his assigned suit; in other versions, he can score with cards of any suit. The solitary player simply plays as each character in the game, rotating from character to character on every turn.

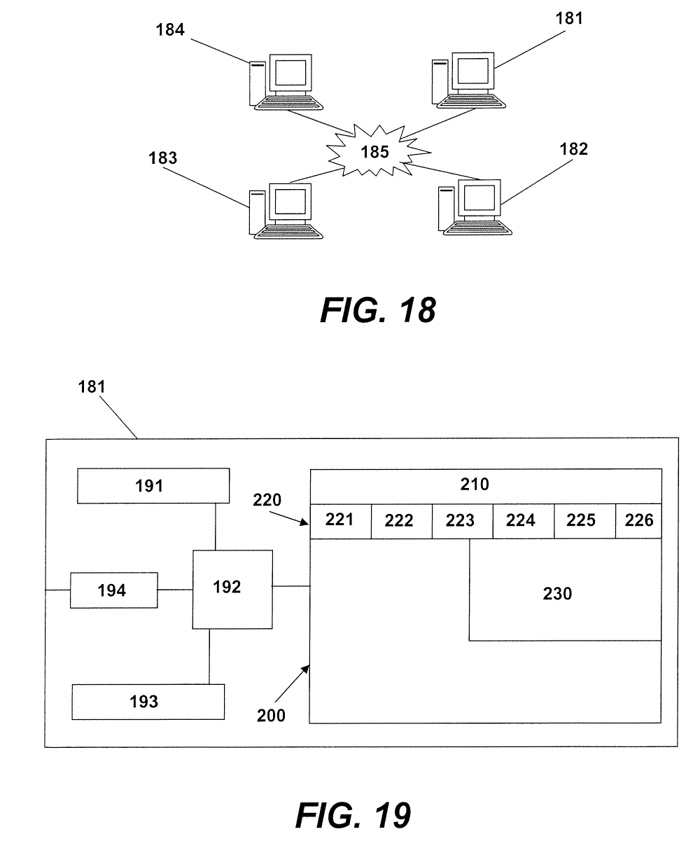

Also contemplated is a computer implemented version of the game. The basic concept and rules of the computer implemented game are the same as in the versions previously discussed with reference to FIGS. 1-17, but without a physical deck of cards held by the players. Referring to FIGS. 18 and 19, the game may be played by multiple players on a single computer 181, or by players on multiple computers 181, 182, 183, and 184. The computers may be connected by any type of network 185, including the internet, as is known in the art. Each computer may comprise a user input device 193 such as a keyboard or mouse, and a display device 191 such as a monitor, printer, or the like. Each computer may also comprise a communication device 194 such as a modem or network adapter. Each computer also comprises a processor 192 and at least one computer readable medium 200, such as a hard disk or memory device. The computerized version of the game may be stored on such a computer readable medium 200. Any or all of the input or display devices, communication devices, processor, and computer readable medium may be distributed over any number of computers, or may be on a single computer.

A database of virtual cards 210 replaces the deck of cards described in reference to FIGS. 1-17. The database of virtual cards 210 is stored on a computer readable medium 200. Virtual cards in the database 210 may have an associated score and suit, or may be unsuited scoring or special cards analogous to those previously discussed in reference to the physical embodiment of the game. The score value of a virtual card may be represented numerically, and the suit of a virtual card may be represented by any suitable identifier, including numbers or letters. Each virtual card in the virtual card database has is assigned a unique identifier so that one virtual card can be distinguished from another. A plurality of databases of virtual hands (collectively 220, individually 221, 222, 223, 224, 225 and 226) store the virtual cards held by each player. Each database of virtual hands also resides on a computer readable medium 200, and is analogous to a hand of cards held by a player in the physical embodiments of the game.

Also residing on the computer readable medium are processor executable instructions 230. These instructions cause a computer to distribute the virtual cards and score the hands and game in a manner analogous to the physical embodiments of the invention described above in reference to FIGS. 1-17. More specifically, the flow charts of FIGS. 1-4 illustrate the logic embodied in the instructions.

To begin, the instructions direct the processor 192 to assign a unique identifier corresponding to each suit to each virtual hand database. This is analogous to assigning a suit (or a character) to a player in the physical embodiments of the game. The instructions 230 then direct the processor 192 to randomly assign a plurality of virtual cards to each virtual hand database 220. This is accomplished by associating the unique identifier of a virtual card with a virtual hand database 220. This step is analogous to dealing the cards in the physical version of the game. Next, the processor 192 causes a display device 191 to display a representation of each virtual card in at least one virtual hand database. This representation may be a graphic representation of a playing card, or it may be plain text and numbers. In this manner, each player can view their “virtual hand” on the display device.

The hand score of each player is then determined when the instructions 230 direct the processor 192 to sum the scores of the virtual cards in each virtual hand database 220. The scoring rules are the same as those described in reference to the embodiments of FIGS. 1-17, and are illustrated in the flow charts of FIGS. 1-4. For example, the hand score for each virtual hand database 220 is determined by adding up the scores of the virtual cards in the same suit, and bonus points are awarded if the virtual cards belong to the suit assigned to the virtual hand database 220, or if all virtual cards in the virtual hand database 220 are played. The hand score is determined for each virtual hand database 220 in order to complete a hand. These steps are repeated for a predetermined number of hands to complete the game. The final score of each player is determined by adding together a predetermined number of hand scores earned throughout the game, just as in the physical embodiments of the game. The player with the highest final score is the winner of the game.

Any of the variations of the game described with respect to the physical embodiments of the game may be incorporated into the computerized version. For example, the variations of the scoring system described above may also be incorporated into the computerized version of the game.

Various modifications and alterations of the invention will become apparent to those skilled in the art without departing from the spirit and scope of the invention, which is defined by the accompanying claims. For example, it should be noted that steps recited in any method claims below do not necessarily need to be performed in the order they are recited. In certain embodiments, steps may be performed simultaneously. Furthermore, any element in a claim that does not explicitly state “means for” performing a specified function or “step for” performing a specified function is not to be interpreted as a “means” or “step” clause as specified in 35 U.S.C. § 112, ¶ 6. The accompanying claims should be constructed with these principles in mind.

What is claimed is:

1. A method for playing a card game using a deck of cards divided into a plurality of suits, the deck of cards comprising suited cards each having a point-value, the method of playing the card game comprising:
a) selecting a group of players to play the game,
b) assigning at least one suit to every player in the group of players,
c) beginning a hand by dealing a hand of cards to every player in the group of players,
d) selecting a first player from the group of players to have a turn, the turn giving the first player the option of drawing a card,
e) selecting a second player from the group of players to have a turn,
f) after every player in the group of players has had at least one turn, determining for each player in the group of players a sum of the point-values of the suited cards in said each player's hand that belong to one suit, and
g) determining a hand score for said each player by adding bonus points to the sum of the point-values of the suited cards in said each player's hand that belong to one suit if said one suit is said each player's assigned suit.

2. The method of claim 1, wherein said each player's hand score does not include a sum of the point-values of suited cards that do not belong to said each player's assigned suit.

3. The method of claim 1, further comprising:
a) repeating steps (c) through (g) of claim 1 a predetermined number of times, and
b) determining said each player's final score, said each player's final score comprising a sum of a predetermined number of said each player's hand scores,
wherein said each player with the highest final score is the winner of the game.

4. The method of claim 3, wherein said predetermined number of times is ten.

5. The method of claim 3, wherein said predetermined number of said each player's hand scores is three.

6. The method of claim 3, wherein said predetermined number of said each player's hand scores are the highest hand scores received during the game by said each player.

7. The method of claim 1 wherein the deck of cards further comprises scoring cards having a values, the method further comprising altering said each player's hand score according to the value of scoring cards in said each player's hand.

8. The method of claim 1 wherein the deck of cards further comprises scoring cards having values, the method further comprising altering said each player's final score according to the value of scoring cards in said each player's hand.

9. The method of claim 1 wherein said at least one suit assigned to each player is selected from a group of six suits of cards.

10. The method of claim 1 wherein the hand of cards comprises five cards.

11. The method of claim 1 wherein the deck of cards includes special cards, the method further comprising a player in the group of players holding a special card taking an action unavailable to any player in the group of players not holding said special card.

12. The method of claim 1 wherein the suit assigned to each player is determined by a roll of a die.

13. The method of claim 1 wherein each suit is associated with a game character.

14. The method of claim 13 further comprising assigning a game character to each player.

15. The method of claim 14 wherein said suit assigned to each player corresponds to the suit of associated with said each player's assigned game character.

16. The method of claim 13 wherein said game characters are athletes.

17. The method of claim 16 wherein the values of the suited cards are associated with actions performed by said athletes.

18. The method of claim 16 wherein the values of the suited cards are associated with maneuvers performed by board riders.

19. An apparatus for playing a virtual card game, the system comprising:
a) a display device,
b) a processor, and
c) a computer readable medium, wherein the computer readable medium contains:
i) a database of virtual cards comprising suited virtual cards having a score and a suit, and wherein no two virtual cards in the database of virtual cards have both the same score and the same suit;
ii) a plurality of virtual hand databases; and
iii) processor executable instructions,
wherein the processor executable instructions direct the processor to:
assign a suit to each virtual hand database,
randomly assign a plurality of virtual cards from the virtual card database to each virtual hand database,
cause the display device to display a representation of the score and the suit of each virtual card in at least one virtual hand database, and
determine a hand score of each virtual hand database by summing the scores of suited virtual cards of one suit in said each virtual hand database, and adding bonus points to the hand score if said one suit is the suit assigned to said each virtual hand database.

20. The apparatus of claim 19, wherein the processor executable instructions direct the processor to determine a hand score of each virtual hand database by summing the scores of only the suited virtual cards in said each virtual hand database that are associated with the suit that is assigned to said each virtual hand database.
